(19) United States
(12) Patent Application Publication
(10) Pub. No.: US 2025/0170966 A1
(43) Pub. Date: May 29, 2025

(54) KAYAK CARRIER

(71) Applicant: WODE GLOBAL (QINGDAO) OUTDOOR CO., LTD., Qingdao City (CN)

(72) Inventor: Yingchun ZHAO, Qingdao City (CN)

(21) Appl. No.: 18/957,613

(22) Filed: Nov. 22, 2024

(30) Foreign Application Priority Data
Nov. 23, 2023 (CN) 202323170965.9

(51) Int. Cl. B60R 9/08

(52) U.S. Cl. CPC B60R 9/08

(57) ABSTRACT

Disclosed is a kayak carrier, including a fixed frame fixedly connected to a top of a vehicle body and used as a bottom supporting structure when a kayak is fixed; a movable frame rotatably connected to the middle portion of the fixed frame, wherein the movable frame and the fixed frame form a supporting structure that supports a kayak body in the horizontal and vertical directions; a locking structure arranged at a connection between the movable frame and the fixed frame and suitable for fixing the position of the movable frame; a connecting assembly connected to the fixed frame and used to connect the fixed frame and a rack on a car roof.

### CROSS-REFERENCE TO RELATED APPLICATIONS

The present application claims priority to and benefit of China patent application No. 202323170965.9, filed on Nov. 23, 2023, which is hereby incorporated by reference in its entirety.

### TECHNICAL FIELD

The application relates to the field of boat peripheral equipment, in particular to a kayak carrier.

### BACKGROUND

Kayak is one of the tools for outdoor water sports. For enthusiasts of this project, they often drive themselves and bring kayaks to the corresponding waters. Kayak is usually carried by fixing it on a top of a car, but the general cargo rack of the car is not suitable for fixing a kayak. Many straps are needed to stably tie the kayak to a car roof.

There are also solutions for fixing kayaks, but the existing solutions require slightly more operation of the frame when fixing the kayak. Because this type of fixed frame is installed on the car roof and the kayak itself is also large in size, it will feel inconvenient in actual operation.

### SUMMARY

In view of one of the deficiencies of the prior art, the application provides a kayak carrier to solve the problem of fixing the kayak to the car roof.

To achieve the above objects, the present application provides a kayak carrier, comprising:
a fixed frame fixedly connected to a top of a vehicle body and used as a bottom supporting structure when a kayak is fixed;
a movable frame rotatably connected to the middle portion of the fixed frame, wherein the movable frame and the fixed frame form a supporting structure that supports a kayak body in the horizontal and vertical directions,
a locking structure arranged at a connection between the movable frame and the fixed frame and suitable for fixing the position of the movable frame;
a connecting assembly connected to the fixed frame and used to connect the fixed frame and a rack on a car roof.

Preferably, the fixed frame comprises:
a middle frame located in the middle portion of the fixed frame and fixedly connected to the rack on the car roof through the connecting assembly, and
end frames located at both ends of the middle frame, wherein the end frames are inclined upward.

Preferably, a lower connecting structure which can be connected to a strap is reserved at one end of the end frame away from the middle frame.

Preferably, the fixed frame comprises:
a first frame comprising a first half frame and one of the end frames;
a second frame comprising a second half frame and the other one of the end frames, wherein the first half frame and the second half frame can be inserted into and connected with each other to form the middle frame.

Preferably, the movable frame comprises:
a side frame, the lower end of which is rotatably connected to the middle frame;
an upper connecting structure, which is arranged at an upper end of the side frame and can be connected to a strap.

Preferably, the locking structure comprises:
a first locking member, one side of which is fixedly connected to the fixed frame and the other side of which is provided with a first engaging portion;
a second locking member provided with a second engaging portion corresponding to the first engaging portion, wherein the second locking member is rotatably connected to the first locking member, and is fixedly connected to a bottom end of the movable frame;
a tensioning member, which passes through the second locking member and is threadedly connected to the first locking member, wherein an axis of a thread structure of the tensioning member is coaxial with a rotation axis of the second locking member.

Preferably, a plurality of teeth are arranged on the opposite sides of the first engaging portion and the second engaging portion, and the teeth are evenly arranged in a circumferential direction around a rotation axis of the first engaging portion and the second engaging portion.

Preferably, the first locking member and the second locking member are formed by casting metal material.

Preferably, a set of the first locking member and the second locking member is respectively provided at both ends of a bottom of the movable frame.

One tensioning member is provided corresponding to one set of the first locking member and the second locking member.

Preferably, the kayak carrier further comprises:
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

Preferably, the kayak carrier further comprises:
a paddle fixing member fixedly connected to the movable frame, wherein the paddle fixing member is annular as a whole and a paddle can be inserted therein.

Compared with the prior art, the application has the following advantages: the device of the present application can be connected to the existing car rack. A support frame structure for placing kayaks is formed on the car roof. By combining the fixed frame and the movable frame, the kayak is placed on the support structure formed by the two. The ends of the fixed frame and the movable frame are connected with a strap to complete the fixing of the kayak, and the operation is very simple

In addition, the movable frame and the fixed frame of the present application can present a variety of structural settings at different angles. The locking structure can be adjusted according to actual needs to achieve the fixation of the first two at different angles. When adjusting this structure, only one side of the tensioning member needs to be adjusted to achieve the locking of both ends of the movable frame, which is very convenient.

### BRIEF DESCRIPTION OF THE DRAWINGS

FIG. 1 is a first schematic view of the overall structure of an embodiment of the present application,

FIG. 2 is a second schematic view of the overall structure of the embodiment of the present application,

FIG. 3 is a partial enlarged view of A in FIG. 1, and

FIG. 4 is a partial enlarged view of B in FIG. 2.

### LISTING OF REFERENCE SIGNS

1 fixed frame
11 first frame
12 second frame
13 lower connecting structure
2 movable frame
21 side frame
22 upper connecting structure
3 locking structure
31 first locking member
32 second locking member
33 tensioning member
4 connecting assembly
5 pad assembly
51 middle pad
52 end pad
53 movable pad
6 paddle fixing member

### DETAILED DESCRIPTION OF EMBODIMENTS

The technical solutions in the embodiments of the present application will be clearly and completely described below with reference to the accompanying drawings in the embodiments of the present application. Obviously, the described embodiments are only some of the embodiments of the present application, rather than all the embodiments. Based on the embodiments of the present application, all other embodiments obtained by those with ordinary skills in the art without creative work are within the scope of protection of the present application.

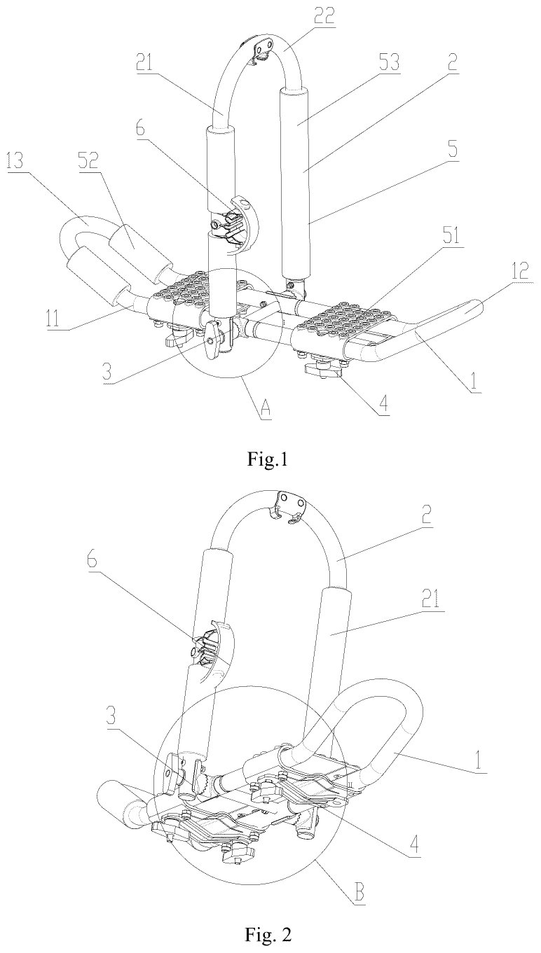

Referring to FIGS. 1 and 2, the application provides the following technical solutions:

A kayak carrier, comprising a fixed frame 1 and a movable frame 2. The fixed frame 1 is fixedly connected to a top of a vehicle body, used as the bottom supporting structure when a kayak is fixed. The movable frame 2 is rotatably connected to the middle portion of the fixed frame 1. The movable frame 2 can form a supporting structure with the fixed frame 1 to support the kayak body in the horizontal and vertical directions. When the movable frame 2 stands upright, the movable frame 2 and the fixed frame 1 present a structure similar to the shape of “L”. A locking structure 3 is provided at a connection between the movable frame 2 and the fixed frame 1, and the locking structure 3 can fix the position of the movable frame 2. A connecting assembly 4 is provided on the lower side of the fixed frame 1, and the fixed frame 1 is connected to the rack on the car roof through the connecting assembly 4.

Through this structure solution, a basic support structure is formed by the fixed frame 1 to lift a bottom of the kayak. Then, the movable frame 2 with adjustable angle is adjusted according to the actual application requirements, and a support structure space is formed on both sides of the movable frame 2 to increase the convenience of use of the carrier.

After placing the kayak and other items, a strap is tied between the outer end of the fixed frame 1 and the top of the movable frame 2, and the kayak or other loads can be fixed by the strap.

On the basis of the above implementation, the fixed frame 1 comprises a middle frame and an end frame. The middle frame is located in the middle portion of the fixed frame 1. The middle frame is fixedly connected to the rack on the car roof through the connecting assembly 4. The end frames are located at both ends of the middle frame. The end frames are inclined upward.

The middle frame and the end frames at both ends form a structure similar to a bottom of a boat. The middle frame forms a horizontal supporting structure on the car roof, while the end frames at both ends are upturned, which can have a certain side blocking effect on the items thereon to prevent the items from falling out during the driving of the car.

On the basis of the above implementation, a lower connecting structure 13 which can be connected to the strap is reserved at an end of the end frames away from the middle frame. This solution only needs to ensure that the end frames can be easily connected to the strap, and the specific structure is not limited.

As an implementation, as shown in FIG. 1 and FIG. 2, the middle frame in this solution is two parallel rods, and the end frames are “U”-shaped, with the closed end facing outward and the open end connected to the middle frame.

On the basis of the above implementation, the fixed frame 1 comprises a first frame 11 and a second frame 12. The first frame 11 comprises a first half frame and an end frame. The second frame 12 comprises a second half frame and another end frame. The first half frame and the second half frame can be inserted into each other to form the middle frame.

In other words, the first frame 11 and the second frame 12 respectively comprise a half of the middle frame, and the first frame 11 and the second frame 12 are inserted into each other and combined to form a complete fixed frame 1. To facilitate the sale and transportation of the product, the fixed frame 1 is divided into a first frame 11 and a second frame 12 for manufacturing. This allows the products to be sold and transported in a disassembled state, saving more space for transportation and storage.

On the basis of the above implementation, the movable frame 2 comprises a side frame 21 and an upper connecting structure 22. The lower end of the side frame 21 is rotatably connected to the middle frame. The upper connecting structure 22 is arranged at an upper end of the side frame 21 and can be connected to the strap.

As before, the specific form of the upper connecting structure 22 is not limited, as long as it is convenient to connect with the strap. The movable frame 2 provided in this solution can adopt an “n”-shaped structure.

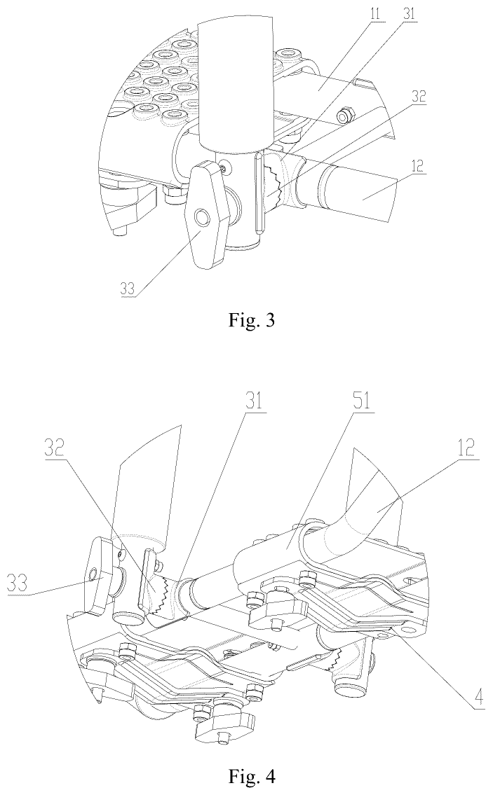

On the basis of the above implementation, referring to FIG. 3, the locking structure 3 comprises a first locking member 31 and a second locking member 32 which can be engaged with each other. A side of the first locking member 31 is fixedly connected to the fixed frame 1, and the other side is provided with a first engaging portion. The second locking member 32 is provided with a second engaging portion corresponding to the first engaging portion. The second locking member 32 is rotatably connected to the first locking member 31, and is fixedly connected to a bottom end of the movable frame 2. The first locking member 31 and the second locking member 32 are tensioned by a tensioning member 33. The tensioning member 33 passes through the second locking member 32 and is threadedly connected to the first locking member 31. An axis of a thread structure of the tensioning member 33 is coaxial with a rotation axis of the second locking member 32.

In this implementation, the first locking member 31 and the second locking member 32 serve as connecting structures of the fixed frame 1 and the movable frame 2, respectively, and by a rotational connection of the first locking member 31 and the second locking member 32, a structural form in which the movable frame 2 can rotate relative to the fixed frame 1 is realized. The tensioning member 33 can be a bolt. A threaded hole is provided at a center axis of the first locking member 31. By screwing the tensioning member 33, the second locking member 32 and the first locking member 31 are tightly attached to each other, thereby achieving locking.

On the basis of the above implementation, referring to FIG. 3, a plurality of teeth are formed on the opposite sides of the first engaging portion and the second engaging portion, and the teeth are evenly arranged in a circumferential direction around a rotation axis of the first engaging portion and the second engaging portion. The first locking member 31 and the second locking member 32 are formed by casting metal material.

With this structure, when the first engaging portion and the second engaging portion are in close contact, and thus will not rotate relative to each other. When the movable frame 2 needs to be rotated, the tensioning member 33 is rotated to allow the first engaging portion and the second engaging portion to be separated laterally and then rotated.

A set of the first locking member 31 and the second locking member 32 is respectively provided at both ends of a bottom of the movable frame 2, and one tensioning member 33 is provided corresponding to one set of the first locking member 31 and the second locking member 32. The locking manner of this structure can make the movable frame 2 very firm in the locked state. Only one tensioning member 33 is required to fix the two ends of the movable frame 2, and there is no need to respectively provide a tensioning member 33 at the two ends of the movable frame 2. When the angle of the movable frame 2 of the carrier needs to be adjusted, it is only necessary to rotate the tensioning member 33 to loosen the first locking members 31 at both ends of the movable frame 2 and the corresponding second locking members 32 to complete the adjustment.

On the basis of the above implementation, a pad assembly 5 is further arranged on the carrier. The pad assembly 5 is arranged on the fixed frame 1 and the movable frame 2. The pad assembly 5 comprises a middle pad 51, an end pad 52 and a movable pad 53.

The middle pad 51 is arranged on the middle frame, and comprises a pad connected to the middle frame, and a plurality of washers are respectively arranged on a side surface of the pad. The washers are annular and made of elastic material. The end pad 52 is arranged on the parallel rod structure of the end frame. The movable pad 53 is arranged on the vertical rod structure of the movable frame 2. The end pad 52 and the movable pad 53 are both cylindrical structures made of elastic material, and materials such as high-density sponge can be selected.

On the basis of the above implementation, referring to FIG. 3 and FIG. 4, a middle pad 51 is respectively provided corresponding to the first frame 11 and the second frame 12, the pads of which have an annular structure and are sleeved on the parallel rods of the middle frame corresponding the two.

The connecting assembly 4 is fixed to a lower side of the pad of the middle pad 51, and a clamping plate structure that is closed up and down is formed on the lower side of the pad, so that the clamping and fixing on the rack of the vehicle body is achieved through this structure.

On the basis of the above implementation, referring to FIGS. 1 and 2, a paddle fixing member 6 is provided on the side frame 21 of the movable frame 2, that is, on a vertical rod of its “n”-shaped structure. The paddle fixing member 6 is annular as a whole and a paddle can be inserted therein.

The specific structure of the paddle fixing member 6 is not limited, as long as it can be connected to the side frame 21 and a paddle can be inserted therein. A clamp-type structure can be used, in which half of the clamp is connected to the side frame 21, and the other half of the clamp is detachably connected, and the paddle handle of the paddle is inserted into the paddle fixing member 6, which is convenient for carrying the paddle.

Based on the above implementation, a hook structure can be provided at a top middle of the movable frame 2 to facilitate the connection of the strap.

Finally, it should be noted that the above is only a preferred embodiment of the present application and is not intended to limit the present application. Although the present application has been described in detail with reference to the aforementioned embodiments, those skilled in the art can still modify the technical solutions described in the aforementioned embodiments or make equivalent replacements for some of the technical features therein. Any modifications, equivalent substitutions, improvements, etc. made within the concept and principles of this application should be included in the protection scope of this application.

What is claimed is:

1. A kayak carrier, comprising
a fixed frame fixedly connected to a top of a vehicle body and used as a bottom supporting structure when a kayak is fixed;
a movable frame rotatably connected to the middle portion of the fixed frame, wherein the movable frame and the fixed frame form a supporting structure that supports a kayak body in the horizontal and vertical directions,
a locking structure arranged at a connection between the movable frame and the fixed frame and suitable for fixing the position of the movable frame;
a connecting assembly connected to the fixed frame and used to connect the fixed frame and a rack on a car roof.

2. The kayak carrier according to claim 1, wherein the fixed frame comprising:
a middle frame located in the middle portion of the fixed frame and fixedly connected to the rack on the car roof through the connecting assembly, and
end frames located at both ends of the middle frame, wherein the end frames are inclined upward.

3. The kayak carrier according to claim 1, wherein a lower connecting structure which can be connected to a strap is reserved at an end of the end frame away from the middle frame.

4. The kayak carrier according to claim 2, wherein the fixed frame comprising:
a first frame, comprising a first half frame and one of the end frames;
a second frame, comprising a second half frame and the other one of the end frames, wherein the first half frame and the second half frame can be inserted into and connected with each other to form the middle frame.

5. The kayak carrier according to claim 1, wherein the movable frame comprising:
a side frame, the lower end of which is rotatably connected to the middle frame;
an upper connecting structure, which is arranged at an upper end of the side frame and can be connected to a strap.

6. The kayak carrier according to claim 1, wherein the locking structure comprising
a first locking member, a side of which is fixedly connected to the fixed frame and the other side of which is provided with a first engaging portion;
a second locking member provided with a second engaging portion corresponding to the first engaging portion, wherein the second locking member is rotatably connected to the first locking member, and is fixedly connected to a bottom end of the movable frame;
a tensioning member, which passes through the second locking member and is threadedly connected to the first locking member.

7. The kayak carrier according to claim 6, wherein a plurality of teeth are arranged on the opposite sides of the first engaging portion and the second engaging portion, and the teeth are evenly arranged in a circumferential direction around a rotation axis of the first engaging portion and the second engaging portion.

8. The kayak carrier according to claim 7, wherein a set of the first locking member and the second locking member is respectively provided at both ends of a bottom of the movable frame, and
one tensioning member is provided corresponding to one set of the first locking member and the second locking member.

9. The kayak carrier according to claim 2, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

10. The kayak carrier according to claim 3, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

11. The kayak carrier according to claim 4, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

12. The kayak carrier according to claim 5, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

13. The kayak carrier according to claim 6, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

14. The kayak carrier according to claim 7, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

15. The kayak carrier according to claim 8, further comprising
a pad assembly arranged on the fixed frame and the movable frame, the pad assembly comprising:
a middle pad arranged on the middle frame, comprising a pad connected to the middle frame, wherein a plurality of washers are arranged on a side of the pad, wherein the washers are annular and made of elastic material;
an end pad arranged on the end frame;
a movable pad arranged on the movable frame.

16. The kayak carrier according to claim 1, further comprising
a paddle fixing member fixedly connected to the movable frame, wherein the paddle fixing member is annular as a whole and a paddle can be inserted therein.

17. The kayak carrier according to claim 2, further comprising
a paddle fixing member fixedly connected to the movable frame, wherein the paddle fixing member is annular as a whole and a paddle can be inserted therein.

18. The kayak carrier according to claim 3, further comprising
a paddle fixing member fixedly connected to the movable frame, wherein the paddle fixing member is annular as a whole and a paddle can be inserted therein.

19. The kayak carrier according to claim 4, further comprising
a paddle fixing member fixedly connected to the movable frame, wherein the paddle fixing member is annular as a whole and a paddle can be inserted therein.

20. The kayak carrier according to claim 5, further comprising
a paddle fixing member fixedly connected to the movable frame, wherein the paddle fixing member is annular as a whole and a paddle can be inserted therein.
